(19) United States
(12) Patent Application Publication
(10) Pub. No.: US 2002/0138274 A1
(43) Pub. Date: Sep. 26, 2002

(54) Server based adaption of acoustic models for client-based speech systems

(76) Inventors: Sangita R. Sharma, Hillsboro, OR (US); Jim A. Larson, Beaverton, OR (US); Mike S. Chartier, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/817,830

(22) Filed: Mar. 26, 2001

(51) Int. Cl. G10L 21/00

(52) U.S. Cl. 704/270

(57) ABSTRACT

The invention provides for the adaption of acoustic models for a client device at a server. For example, a server can couple to a client device having speech recognition functionality. An acoustic model adaptor can be located at the server and can be used to adapt an acoustic model for the client device. The client device can be a mobile computing device and the server can be coupled to the mobile client device through a network. The acoustic model adaptor adapts the acoustic model for the mobile client device based upon digitized raw speech data or extracted speech feature data received from the client device when there is a network connection between the client device and the server. The server stores the adapted acoustic model. The mobile client device can download the adapted acoustic model and store the adapted acoustic model locally at the client device.

### BACKGROUND

1. Field of the Invention

This invention relates to speech recognition systems. In particular, the invention relates to server based adaption of acoustic models for client-based speech systems.

2. Description of Related Art

Today, speech is emerging as the natural modality for human-computer interaction. Individuals can now talk to computers via spoken dialogue systems that utilize speech recognition. Although human-computer interaction by voice is available today, a whole new range of information/communication services will soon be available for use by the public utilizing spoken dialogue systems. For example, individuals will soon be able to talk to a computing device to check e-mail, perform banking transactions, make airline reservations, look up information from a database, and perform a myriad of other functions. Moreover, the notion of computing is expanding from standard desktop personal computers (PCs) to small mobile hand-held client devices and wearable computers. Individuals are now utilizing mobile client devices to perform the same functions previously only performed by desktop PCs and other specialized functions pertinent to mobile client devices.

It should be noted that there are different types of speech or voice recognition applications. For example, command and control applications typically have a small vocabulary and are used to direct the client device to perform specific tasks. An example of a command and control application would be to direct the client device to look up the address of a business associate stored in the local memory of the client device or in a database at a server. On the other hand, natural language processing applications typically have a large vocabulary and the computer analyzes the spoken words to try and determine what the user wants and then performs the desired task. For example, a user may ask the client device to book a flight from Boston to Portland and a server computer will determine that the user wants to make an airline reservation for a flight departing from Boston and arriving at Portland and the server computer will then perform the transaction to make the reservation for the user.

Speech recognition entails machine conversion of sounds, created by natural human speech, into a machine-recognizable representation indicative of the word or the words actually spoken. Typically, sounds are converted to a speech signal, such as a digital electrical signal, which a computer then processes. Generally, the computer uses speech recognition algorithms, which utilize statistical models for performing pattern recognition. As with any statistical technique, a large amount of data is required to compute reliable and robust statistical acoustic models.

Most currently commercially-available speech recognition systems include computer programs that process a speech signal using statistical models of speech signals generated from a database of different spoken words. Typically, these speech recognition systems are based on principles of statistical pattern recognition and generally employ an acoustic model and a language model to decode an input sequence of observations (e.g. acoustic signals) representing input speech (e.g. a word, string of words, or sentence) to determine the most probable word, word sequence, or sentence given the input sequence of observations. Thus, typical modern speech recognition systems search through potential words, word sequences, or sentences and choose the word, word sequence, or sentence that has the highest probability of re-creating the input speech. Moreover, speech recognition systems can be speaker-dependent systems (i.e. a system trained to the characteristics of a specific user's voice) or speaker-independent systems (i.e. a system useable by any person).

A speech signal has several variabilities such as speaker variabilities due to gender, age, accent, regional pronunciations, individual idiosyncrasies, emotions, and health factors, and environmental variabilities due to microphones, transmission channel, background noise, reverberation, etc. These variabilities make the parameters of the statistical models for speech recognition difficult to estimate. One approach to deal with these variabilities is the adaption of the statistical acoustic models as more data becomes available due to usage of the speech recognition system, as in a speaker-dependent system. Such an adaption of the acoustic model is known to significantly improve the recognition accuracy of the speech recognition system. However, small mobile client computing devices are inherently limited in processing power and memory availability, making adaption of acoustic models or any re-training difficult for the mobile computing device. As a result, acoustic model adaption in small mobile client devices is most often not performed. Unfortunately, the mobile client device must rely on the original acoustic models that are not often well matched to the user's speaking variabilities and environmental variabilities, which results in reduced speech recognition accuracy and detrimentally impacts the user's experience in utilizing the mobile client device.

### BRIEF DESCRIPTION OF THE DRAWINGS

The features and advantages of the present invention will become apparent from the following description of the present invention in which:

FIG. 1 is a block diagram illustrating an exemplary environment in which an embodiment of the invention can be practiced.

FIG. 2 is a block diagram further illustrating the exemplary environment and illustrating an exemplary implementation of an acoustic model adaptor according to one embodiment of the present invention.

FIG. 3 is a flowchart illustrating a process for the adaption of acoustic models for client-based speech systems according to one embodiment of the present invention.

### DESCRIPTION

The invention relates to the server based adaption of acoustic models for client-based speech systems. Particularly, the invention provides a method, apparatus, and system for the adaption of acoustic models for a client device at a server.

In one embodiment of the invention, a server can couple to a client device having speech recognition functionality. An acoustic model adaptor can be located at the server and can be used to adapt an acoustic model for the client device.

In particular embodiments of the invention, the client device can be a small mobile computing device and the server can be coupled to the mobile client device through a network. The acoustic model adaptor adapts the acoustic model for the mobile client device based upon digitized raw speech data or extracted speech feature data received from the client device when there is a network connection between the client device and the server. The server stores the adapted acoustic model. The mobile client device can download the adapted acoustic model and store and use the adapted acoustic model locally at the client device. This is advantageous because the regular updating of acoustic models is known to improve speech recognition accuracy.

Moreover, because mobile client devices with speech recognition functionality are typically single-user systems, the adaption of acoustic models with a user's speech will particularly improve the recognition accuracy for that user. Thus, the user's experience is enhanced because the client device's speech recognition accuracy is continuously improved with more usage. Also, the computational overhead of the mobile client device is significantly reduced, since the client device does not have to adapt the acoustic model itself. This is important because mobile client devices are inherently limited in their processing power and memory availability such that the adaption of acoustic models is very difficult and is most often not performed by mobile client devices. Accordingly, embodiments of the invention make the adaption of acoustic models for the users of mobile client devices feasible.

In the following description, the various embodiments of the present invention will be described in detail. However, such details are included to facilitate understanding of the invention and to describe exemplary embodiments for implementing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, types of data, protocols, procedures, components, networking equipment, speech recognition components, electrical structures and circuits, are not described in detail, or are shown in block diagram form, in order not to obscure the present invention. Furthermore, aspects of the invention will be described in particular embodiments but may be implemented in hardware, software, firmware, middleware, or a combination thereof.

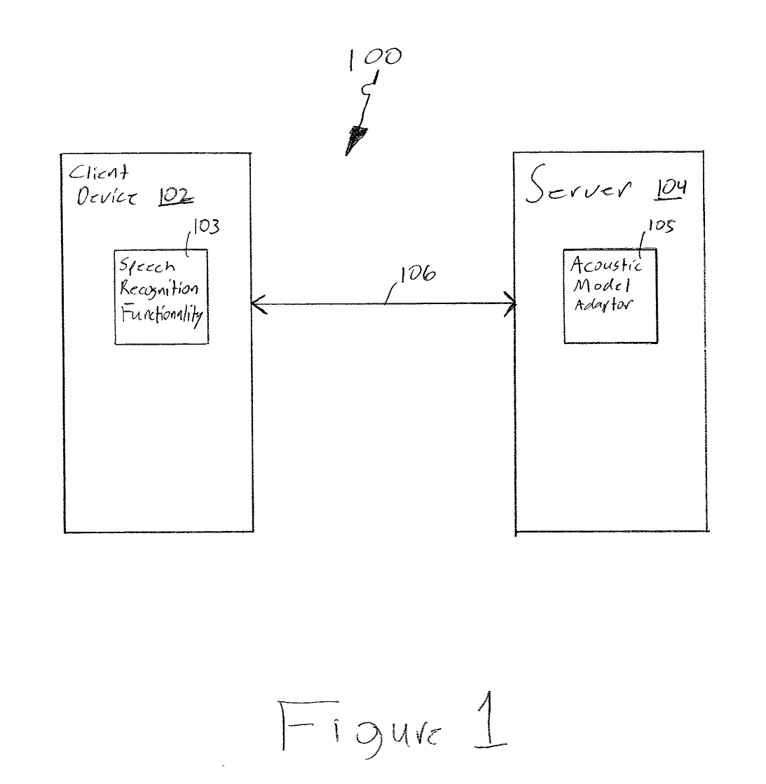

FIG. 1 is a block diagram illustrating an exemplary environment 100 in which an embodiment of the invention can be practiced. As shown in the exemplary environment 100, a client device 102 can be coupled to a server 104 through a link 106. Generally, the environment 100 is a voice and data communications system capable of transmitting voice and audio, data, multimedia (e.g. a combination of audio and video), Web pages, video, or generally any sort of data.

The client device 102 has speech recognition functionality 103. The client device 102 can include cell-phones and other small mobile computing devices (e.g. personal digital assistant (PDA), a wearable computer, a wireless handset, a Palm Pilot, etc.), or any other sort of mobile device capable of processing data. However, it should be appreciated that the client device 102 can be any sort of telecommunication device or computer system (e.g. personal computer (laptop/desktop), network computer, server computer, or any other type of computer).

The server 104 includes an acoustic model adaptor 105. The acoustic model adaptor 105 can be used to adapt an acoustic model for the client device 102. As will be discussed, the acoustic model adaptor 105 adapts the acoustic model for the mobile client device 102 based upon digitized raw speech data or extracted speech feature data received from the client device, which the mobile client device can download from the server 104, store locally, and utilize to improve speech recognition accuracy.

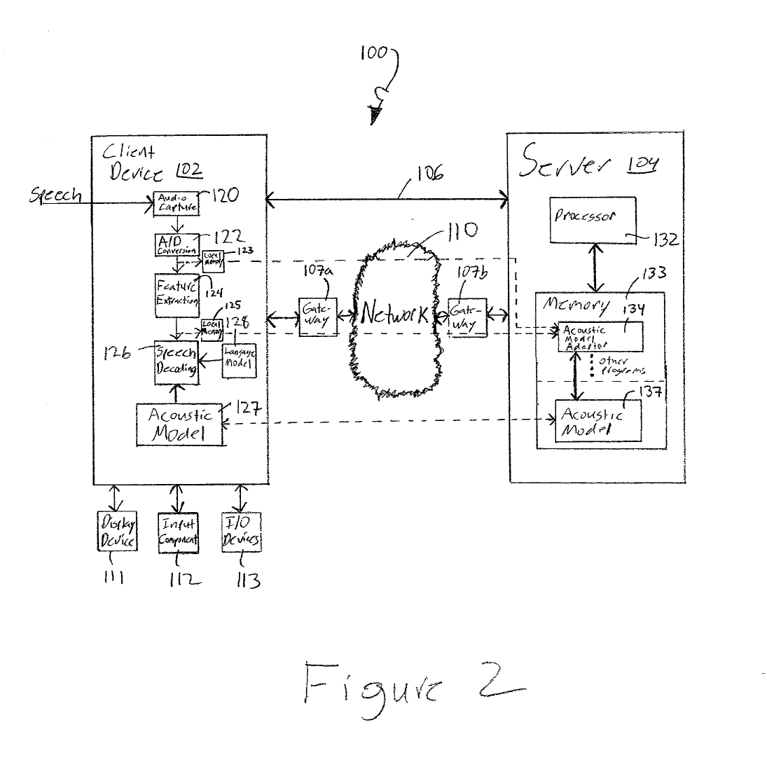

FIG. 2 is a block diagram further illustrating the exemplary environment 100 and illustrating an exemplary implementation of an acoustic model adaptor according to one embodiment of the present invention. As is illustrated in FIG. 2, the mobile client device 102 is bi-directionally coupled to the server 104 via the link 106. A “link” is broadly defined as a communication network formed by one or more transport mediums. The client device 102 can communicate with the server 104 via a link utilizing one or more of a cellular phone system, the plain old telephone system (POTS), cable, Digital Subscriber Line, Integrated Services Digital Network, satellite connection, computer network (e.g. a wide area network (WAN), the Internet, or a local area network (LAN), etc.), or generally any sort of private or public telecommunication system, and combinations thereof. Examples of a transport medium include, but are not limited or restricted to electrical wire, optical fiber, cable including twisted pair, or wireless channels (e.g. radio frequency (RF), terrestrial, satellite, or any other wireless signaling methodology). In particular, the link 106 may include a network 110 along with gateways 107a and 107b.

The gateways 107a and 107b are used to packetize information received for transmission across the network 110. A gateway 107 is a device for connecting multiple networks and devices that use different protocols. Voice and data information may be provided to a gateway 107 from a number of different sources and in a variety of digital formats.

The network 110 is typically a computer network (e.g. a wide area network (WAN), the Internet, or a local area network (LAN), etc.), which is a packetized or a packet switched network that can utilize Internet Protocol (IP), Asynchronous Transfer Mode (ATM), Frame Relay (FR), Point-to-Point Protocol (PPP), Voice over Internet Protocol (VoIP), or any other sort of data protocol. The computer network 110 allows the communication of data traffic, e.g. voice/speech data and other types of data, between the client device 102 and the server 104 using packets. Data traffic through the network 110 may be of any type including voice, audio, graphics, video, e-mail, Fax, text, multi-media, documents and other generic forms of data. The computer network 110 is typically a data network that may contain switching or routing equipment designed to transfer digital data traffic. At each end of the environment 100 (e.g. the client device 102 and the server 104) the voice and/or data traffic requires packetization (usually done at the gateways 107) for transmission across the network 110. It should be appreciated that the FIG. 2 environment is only exemplary and that embodiments of the present invention can be used with any type of telecommunication system and/or computer network, protocols, and combinations thereof.

In an exemplary embodiment, the client device 102 generally includes, among other things, a processor, data storage devices such as non-volatile and volatile memory, and data communication components (e.g. antennas, modems, or other types of network interfaces etc.). Moreover, the client device 102 may also include display devices 111 (e.g. a liquid crystal display (LCD)) and an input component 112. The input component 112 may be a keypad, or, a screen that further includes input software to receive written information from a pen or another device. Attached to the client device 102 may be other Input/Output (I/O) devices 113 such as a mouse, a trackball, a pointing device, a modem, a printer, media cards (e.g. audio, video, graphics), network cards, peripheral controllers, a hard disk, a floppy drive, an optical digital storage device, a magneto-electrical storage device, Digital Video Disk (DVD), Compact Disk (CD), etc., or any combination thereof. Those skilled in the art will recognize any combination of the above components, are any number of different components, peripherals, and other devices, may be used with the client device 102, and that this discussion is for explanatory purposes only.

In continuing with the example of an exemplary client device 102, the client device 102 generally operates under the control of an operating system that is booted into the non-volatile memory of the client device for execution when the client device is powered-on or reset. In turn, the operating system controls the execution of one or more computer programs. These computer programs typically include application programs that aid the user in utilizing the client device 102. These application programs include, among other things, e-mail applications, dictation programs, word processing programs, applications for storing and retrieving addresses and phone numbers, applications for accessing databases (e.g. telephone directories, maps/directions, airline flight schedules etc.), and other application programs which the user of a client device 102 would find useful.

The exemplary client device 102 additionally includes an audio capture module 120, analog to digital (A/D) conversion functionality 122, local A/D memory 123, feature extraction 124, local feature extraction memory 125, a speech decoding function 126, an acoustic model 127, and a language model 128.

The audio capture module 120 captures incoming speech from a user of the client device 102. The audio capture module 120 connects to an analog speech input device (not shown), such as a microphone, to capture the incoming analog signal that is representative of the speech of the user. For example, the audio capture module 120 can be a memory device (e.g. an analog memory device).

The input analog signal representing the speech of the user, which is captured by the audio capture module 120, is then digitized by analog to digital conversion functionality 122. An analog-to-digital (A/D) converter typically performs this function. A local A/D memory 123 can store digitized raw speech signals when the client device 102 is not connected to the server 104. When the client device 102 connects to the server 104, the client device 102 can transmit the locally stored digitized raw speech signals to the acoustic model adaptor 134. Of course, the client device 102 can operate utilizing speech recognition functionality while connected to the server 104, in which case, the digitized raw speech signals can be simultaneously transmitted to the server without storage. The acoustic model adaptor 134 can utilize the digitized raw speech signals to adapt the acoustic model for the mobile client device 102, as will be discussed.

Feature extraction 124 is used to extract selected information from the digitized input speech signal to characterize the speech signal. Typically, for every 10-20 milliseconds of input digitized speech signal, the feature extractor converts the signal to a set of measurements of factors such as pitch, energy, envelope of the frequency spectrum, etc. By extracting these features the correct phonemes of the input speech signal can be more easily identified (and discriminated from one another) in the decoding process, to be discussed later. Feature extraction is basically a data-reduction technique to faithfully describe the salient properties of the input speech signal thereby cleaning up the speech signal and removing redundancies. A local feature extraction memory 125 can store extracted speech feature data when the client device 102 is not connected to the server 104. When the client device 102 connects to the server 104, the client device 102 can transmit the extracted speech feature data to the acoustic model adaptor 134 in lieu of the raw digitized speech samples. Of course, the client device 102 can operate utilizing speech recognition functionality while connected to the server 104, in which case, the extracted speech feature data can be simultaneously transmitted to the server without storage. The acoustic model adaptor 134 can utilize the extracted speech feature data to adapt the acoustic model for the mobile client device 102, as will be discussed.

The speech decoding function 126 utilizes the extracted features of the input speech signal to compare against a database of representative speech input signals. Generally, the speech decoding function 126 utilizes statistical pattern recognition and employs an acoustic model 127 and a language model 128 to decode the extracted features of the input speech. The speech decoding function 126 searches through potential phonemes and words, word sequences, or sentences utilizing the acoustic model 127 and the language model 128 to choose the word, word sequence, or sentence that has the highest probability of re-creating the input speech used by the speaker. For example, the mobile client device 102 utilizing speech recognition functionality could be used for a command and control application to perform a specific task such as to look up an address of a business associate stored in the memory of the client device based upon a user asking the client device to look up the address.

As shown in the exemplary environment 100, a server computer 104 can be coupled to the client device 102 through a link 106, or more particularly, a network 110. Typically the server computer 104 is a high-end server computer but can be any type of computer system that includes circuitry capable of processing data (e.g. a personal computer, workstation, minicomputer, mainframe, network computer, laptop, desktop, etc.). Also, the server computer 104 includes a module to update the acoustic model for the client device, as will be discussed. The server 104 stores a copy acoustic model 137 of the acoustic model 127 used by the client device 102. It should be appreciated that the server can also store many different copies of acoustic models corresponding to many different acoustic models utilized by the client device.

According to one embodiment of the invention, an acoustic model adaptor 134 adapts the acoustic model 127 for the mobile client device 102 based upon digitized raw speech data or extracted speech feature data received from the client device via network 110 when there is a network connection between the client device 102 and the server 104. The client device 102 may operate with a constant connection to the server 104 via network 110 and the server continuously receives digitized raw speech data (after A/D conversion 122) or extracted speech feature data (after feature extraction 124) from the client device. In other embodiments, the client device may intermittently connect to the server such that the server intermittently receives digitized raw speech data stored in local A/D memory 123 of the client device or extracted speech feature data stored in local feature extraction memory 125 of the client device. For example, this could occur when the client device 102 connects to the server 104 through the network 110 (e.g. the Internet) to check e-mail. In additional embodiments, the client device 102 can operate with a constant connection to the server computer 104, and the server performs the desired computing tasks (e.g. looking up the address of business associate, checking e-mail etc.), as well as, updating the acoustic model for the client device.

In either case, the acoustic model adaptor 134 of the server 104 utilizes the digitized raw speech data or extracted speech feature data to adapt the acoustic model 137. Different methods, protocols, procedures, and algorithms for adapting acoustic models are known in the art. For example, the acoustic model adaptor 134 may adapt the client acoustic model 137 by utilizing algorithms such as maximum-likelihood linear regression or parallel model combination. Moreover, the server 104 may use the word, word sequence or sentences decoded by the speech decoding function 126 on the client 102 for processing to perform a function (e.g. to download e-mail to the client device, to look up an address, or to make an airline reservation). Once the acoustic model 137 has been adapted, the mobile client device 102 can download the adapted acoustic model 137 via network 110 and store the adapted acoustic model 127 locally at the client device. This is advantageous because the updated acoustic model 127 will improve speech recognition accuracy during speech decoding 126. Thus, the user's experience is enhanced because the client device's speech recognition accuracy is continuously improved with more usage. It should be appreciated that the server can also store many different copies of acoustic models corresponding to many different acoustic models utilized by the client device. Also, memory requirements for the client device are minimized because different acoustical models can be downloaded as the client usage is changed due to a different user, different noise environments, different applications, etc.

Additionally, the computational overhead of the mobile client device is significantly reduced, since the client device does not have to adapt the acoustic model itself. This is important because mobile client devices are inherently limited in their processing power and memory availability such that the adaption of acoustic models is very difficult and is most often not performed by mobile client devices. Accordingly, embodiments of the invention make the adaption of acoustic models for the users of mobile client devices feasible.

Embodiments of the acoustic model adaptor 134 of the invention can be implemented in hardware, software, firmware, middleware or a combination thereof. In one embodiment, the acoustic model adaptor 134 can be generally implemented by the server computer 104 as one or more instructions to perform the desired functions.

In particular, in one embodiment of the invention, the acoustic model adaptor 134 can be generally implemented in the server computer 104 having a processor 132. The processor 132 processes information in order to implement the functions of the acoustic model adaptor 134. As illustrative examples, the “processor” may include a digital signal processor, a microcontroller, a state machine, or even a central processing unit having any type of architecture, such as complex instruction set computers (CISC), reduced instruction set computers (RISC), very long instruction word (VLIW), or hybrid architecture. The processor 202 may be part of the overall server computer 104 or may be specific for the acoustic model adaptor 134. As shown, the processor 132 is coupled to a memory 133. The memory 133 may be part of the overall server computer 104 or may be specific for the acoustic model adaptor 134. The memory 133 can be non-volatile or volatile memory, or any other type of memory, or any combination thereof. Examples of non-volatile memory include flash memory, Read-only-Memory (ROM), a hard disk, a floppy drive, an optical digital storage device, a magneto-electrical storage device, Digital Video Disk (DVD), Compact Disk (CD), and the like whereas volatile memory includes random access memory (RAM), dynamic random access memory (DRAM) or static random access memory (SRAM), and the like. The acoustic models may be stored in memory 133.

The acoustic model adaptor 134 can be implemented as one or more instructions (e.g. code segments), such as an acoustic model adaptor computer program, to perform the desired functions of adapting the acoustic model 137 for the mobile client device 102 based upon digitized raw speech data or extracted speech feature data received from the client device when there is a network connection between the client device and the server. The instructions which when read and executed by a processor (e.g. processor 132), cause the processor to perform the operations necessary to implement and/or use embodiments of the invention. Generally, the instructions are tangibly embodied in and/or readable from a machine-readable medium, device, or carrier, such as memory, data storage devices, and/or a remote device contained within or coupled to the server computer 104. The instructions may be loaded from memory, data storage devices, and/or remote devices into the memory 133 of the acoustic model adaptor 134 for use during operations. The server computer 104 may include other programs such as e-mail applications, dictation programs, word processing programs, applications for storing and retrieving addresses and phone numbers, applications for accessing databases (e.g. telephone directories, maps/directions, airline flight schedules etc.), and other programs which the user of a client device 102 interacting with the server 104 would find useful.

Those skilled in the art will recognize that the exemplary environments illustrated in FIGS. 1 in 2 are not intended to limit the present invention. Indeed, those skilled in the art will recognize that other alternative system environments, client devices, and servers may be used without departing from the scope of the present invention. Furthermore, while aspects of the invention and various functional components have been described in particular embodiments, it should be appreciated these aspects and functionalities can be implemented in hardware, software, firmware, middleware or a combination thereof.

Various methods, processes, procedures and/or algorithms will now be discussed to implement certain aspects of the invention.

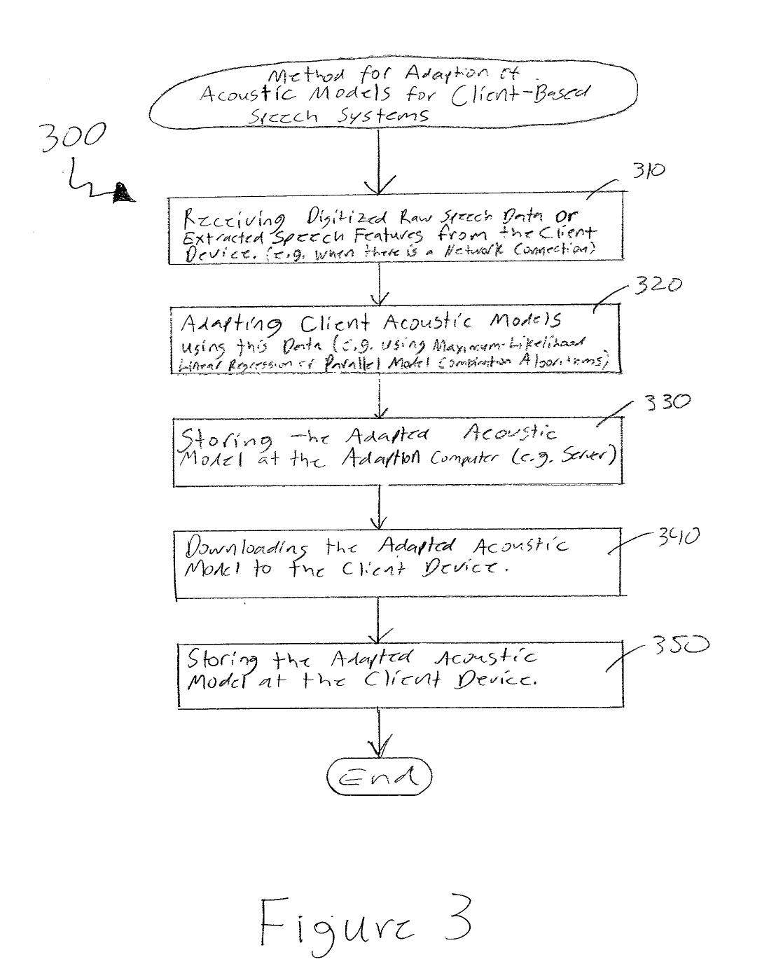

FIG. 3 is a flowchart illustrating a process 300 for the adaption of acoustic models for client-based speech systems according to one embodiment of the present invention.

At block 310, the process 300 receives digitized raw speech data or extracted speech features from the client device (block 310). For example, this can occur when there is a network connection between the client device and a server, either continuously or intermittently. Next, the process 300 adapts the client acoustic model based upon this data (e.g. using a maximum-likelihood linear regression algorithm or a parallel model combination algorithm) (block 320). The process 300 then stores the adapt to the acoustic model at the adaption computer (e.g. a server computer) (block 330).

The process 300 downloads the adapted acoustic model to the client device (block 340). The process 300 then stores the adapted acoustic model at the client device (block 350). This is advantageous because the updating of acoustic models is known to improve speech recognition accuracy.

Thus, in embodiments of the invention a small mobile client device and a server can be coupled through a network. The acoustic model adaptor adapts the acoustic model for the mobile client device based upon digitized raw speech data and/or extracted speech feature data received from the client device when there is a network connection between the client device and the server. The server stores the adapted acoustic model. The mobile client device can download the adapted acoustic model and store the adapted acoustic model locally at the client device. This is advantageous because the regular updating of acoustic models is known to improve speech recognition accuracy and since mobile client devices with speech recognition functionality are typically single-user systems, the adaption of acoustic models with a user's speech will particularly improve the recognition accuracy for that user. Thus, the user's experience is enhanced because the client device's speech recognition accuracy is continuously improved with more usage utilizing embodiments of the invention. Moreover, embodiments of the invention can be incorporated in any speech recognition application where the recognition algorithm is running on a small mobile client device with limited computing capabilities and where a connection, either continuous or intermittent, to the server is expected. Use of the present invention results in significant improvements in recognition accuracy for a mobile client device and hence a better user experience.

While the present invention and its various functional components have been described in particular embodiments, it should be appreciated that the present invention can be implemented in hardware, software, firmware, middleware or a combination thereof and utilized in systems, subsystems, components, or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g. a processor, a computer, etc.). Examples of the machine/processor-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

In particular, in one embodiment of the present invention, the acoustic model adaptor can be generally implemented in a server computer, to perform the desired operations, functions, and processes as previously described. The instructions (e.g. code segments) when read and executed by the acoustic model adaptor and/or server computer, cause the acoustic model adaptor and/or server computer to perform the operations necessary to implement and/or use the present invention. Generally, the instructions are tangibly embodied in and/or readable from a device, carrier, or media, such as memory, data storage devices, and/or a remote device contained within or coupled to the client device. The instructions may be loaded from memory, data storage devices, and/or remote devices into the memory of the acoustic model adaptor and/or server computer for use during operations.

Thus, the acoustic model adaptor according to one embodiment of the present invention may be implemented as a method, apparatus, or machine-readable medium (e.g. a processor readable medium or a computer readable medium) using standard programming and/or engineering techniques to produce software, firmware, hardware, middleware, or any combination thereof. The term “machine readable medium” (or alternatively, “processor readable medium” or “computer readable medium”) as used herein is intended to encompass a medium accessible from any machine/process/computer for reading and execution. Of course, those skilled in the art will recognize that many modifications may be made to this configuration without departing from the scope of the present invention.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. An apparatus comprising:
a server to couple to a client device having speech recognition functionality; and
an acoustic model adaptor locatable at the server to adapt an acoustic model for the client device.

2. The apparatus of claim 1, wherein the client device is a mobile computing device.

3. The apparatus of claim 1, wherein the server is coupled to the client device through a network.

4. The apparatus of claim 1, wherein the client device includes local memory to store digitized raw speech data.

5. The apparatus of claim 1, wherein the client device includes local memory to store extracted speech feature data.

6. The apparatus of claim 1, wherein the acoustic model adaptor of the server receives digitized raw speech data when there is a network connection between the client device and the server.

7. The apparatus of claim 1, wherein the acoustic model adaptor of the server receives extracted speech feature data when there is a network connection between the client device and the server.

8. The apparatus of claim 1, wherein the acoustic model adaptor of the server adapts the acoustic model for the client device based upon at least one of digitized raw speech data or extracted speech feature data received from the client device when there is a network connection between the client device and the server.

9. The apparatus of claim 8, wherein the server stores the adapted acoustic model.

10. The apparatus of claim 8, wherein the client device downloads and stores the adapted acoustic model.

11. A method comprising:
storing a copy of an acoustic model for a client device having speech recognition functionality;
receiving speech data from the client device; and
adapting the acoustic model for the client device.

12. The method of claim 11, wherein the client device is a mobile computing device.

13. The method of claim 11, wherein a server stores the acoustic model for the client device and the client device couples to the server through a network such that the server receives the speech data from the client device.

14. The method of claim 11, wherein the client device includes local memory to store digitized raw speech data.

15. The method of claim 11, wherein the client device includes local memory to store extracted speech feature data.

16. The method of claim 11, wherein the speech data includes digitized raw speech data.

17. The method of claim 11, wherein the speech data includes extracted speech feature data.

18. The method of claim 11, wherein, adapting the acoustic model for the client device includes adapting the acoustic model based upon at least one of digitized raw speech data or extracted speech feature data received from the client device when there is a network connection between the client device and the server.

19. The method of claim 18, further comprising, storing the adapted acoustic model.

20. The method of claim 18, wherein the client device downloads and stores the adapted acoustic model.

21. A system comprising:
a server to couple to a client device having speech recognition functionality, the client device and server being coupled through a network; and
an acoustic model adaptor locatable at the server to adapt an acoustic model for the client device.

22. The system of claim 21, wherein the client device is a mobile computing device.

23. The system of claim 21, wherein the acoustic model adaptor of the server adapts the acoustic model for the client device based upon at least one of digitized raw speech data or extracted speech feature data from the client device when there is a network connection between the client device and the server.

24. The system of claim 23, wherein the server stores the adapted acoustic model.

25. The system of claim 23, wherein the client device downloads and stores the adapted acoustic model.

26. A machine-readable medium having stored thereon instructions, which when executed by a machine, causes the machine to perform the following:
storing a copy of an acoustic model for a client device having speech recognition functionality;
receiving speech data from the client device; and
adapting the acoustic model for the client device.

27. The machine-readable medium of claim 26, wherein the client device is a mobile computing device.

28. The machine-readable medium of claim 26, wherein a server stores the acoustic model for the client device and the client device couples to the server through a network such that the server receives the speech data from the client device.

29. The machine-readable medium of claim 26, wherein the client device includes local memory to store digitized raw speech data.

30. The machine-readable medium of claim 26, wherein the client device includes local memory to store extracted speech feature data.

31. The machine-readable medium of claim 26, wherein the speech data includes digitized raw speech data.

32. The machine-readable medium of claim 26, wherein the speech data includes extracted speech feature data.

33. The machine-readable medium of claim 26, wherein, adapting the acoustic model for the client device includes adapting the acoustic model based upon at least one of digitized raw speech data or extracted speech feature data received from the client device when there is a network connection between the client device and the server.

34. The machine-readable medium of claim 33, further comprising, storing the adapted acoustic model.

35. The machine-readable medium of claim 33, wherein the client device downloads and stores the adapted acoustic model.

36. An apparatus comprising:
means for storing a copy of an acoustic model for a client device having speech recognition functionality; and
means for adapting the acoustic model for the client device based upon speech data received from the client device.

37. The apparatus of claim 36, wherein the client device is a mobile computing device.

38. The apparatus of claim 36, wherein the means for adapting the acoustic model for the client device includes adapting the acoustic model based upon at least one of digitized raw speech data or extracted speech feature data from the client device.

39. The apparatus of claim 38, wherein a server stores the adapted acoustic model.

40. The apparatus of claim 38, wherein the client device downloads and stores the adapted acoustic model.
